(19) United States
(12) Patent Application Publication
(10) Pub. No.: US 2026/0322734 A1
(43) Pub. Date: Oct. 15, 2026

(54) SYSTEMS AND METHODS FOR PRIORITIZING AN EMERGENCY MESSAGE IN AN AUDIO-OVER-INTERNET PROTOCOL TRANSMISSION CHAIN

(71) Applicant: Digital Alert Systems, Inc., Lyndonville, NY (US)

(72) Inventors: Edward CZARNECKI, Herndon, VA (US); William G. ROBERTSON, Bradenton, FL (US)

(73) Assignee: Digital Alert Systems, Inc., Lyndonville, NY (US)

(21) Appl. No.: 19/636,264

(22) Filed: Apr. 1, 2026

Related U.S. Application Data
(60) Provisional application No. 63/788,302, filed on Apr. 14, 2025.

(51) Int. Cl. H04L 45/16; H04L 45/02; H04W 4/90

(52) U.S. Cl. CPC H04L 45/16; H04L 45/02; H04W 4/90

(57) ABSTRACT

A method for transmitting an emergency message signal through an Audio-over-Internet Protocol transmission chain includes detecting an emergency message signal. An initial routing state is read and stored as a new routing state in a memory. The initial routing state is configured to transmit audio input signals through a transmission chain. A priority control signal is generated to change the initial routing state to a priority routing state. The priority routing state is configured to transmit the emergency message signal through the transmission chain. During the transmission of the emergency message signal, additional routing states, associated with incoming routing state change requests from an audio input control signal, are stored in the memory as the new routing state. Each additional routing state replaces the previously stored new routing state. After transmission of the emergency message signal, the routing system is restored to the most recently stored new routing state.

### CROSS REFERENCE TO RELATED APPLICATIONS

This application is a non-provisional application of, and claims the benefit of the filing date of, U.S. Provisional Application No. 63/788,302, filed Apr. 14, 2025. The contents of the aforementioned applications are incorporated herein by reference in their entirety.

### TECHNICAL FIELD

The present disclosure relates to systems and methods of transmitting an emergency message. More specifically, the disclosure relates to systems and methods of transmitting an emergency message over an Audio-over-Internet Protocol (AoIP) transmission chain.

### BACKGROUND

The Federal Communication Commission's Emergency Alert System is a U.S. national public warning system commonly used by state and local authorities to deliver important emergency information, such as weather and AMBER alerts, to affected communities.

Broadcasters are required to provide the capability to transmit certain emergency messages over their regularly scheduled programs.

In previous mainly analog broadcasting systems, the system, used to provide this capability and transmit such emergency messages (referred to herein as an “EAS system”), consisted of an encoder/decoder with hard-wired switches. The hard-wired EAS system was meant to be the last program switch in the transmission chain (sometimes known as the “air chain”), that transmitted from the audio playout of an audio broadcasting system to the transmitter.

Inserting such previous hard-wired EAS systems into the transmission chain was easily accomplished because the EAS system became part of the transmission chain, in serial connection between the audio playout and the transmitter. Therefore, the hard-wired switches of the EAS system could switch to a first position to interrupt the normal audio output, insert the emergency message, and then switch back to the primary position at the end of the emergency message to allow the normal audio output to be restored onto the transmission chain.

However, audio broadcasting has evolved to a mainly digital format, wherein Audio-over IP (AoIP) protocols dominate much of digital broadcasting. AoIP refers to the transmission of digital audio signals over an Internet Protocol network (like the internet or a local network). AoIP offers flexibility and scalability for audio distribution.

Problematically, for current hard-wired EAS systems, in a digital system, routing systems are used to provide virtual switching between different routing states for routing different audio inputs through the transmission chain. Moreover, the routing systems are constantly receiving state change requests from audio control signals from the broadcasting system to change their routing states to meet various programming requirements.

As such, current hard-wired EAS systems cannot be placed in series with, or take the place of, the routing systems. Further the current EAS systems cannot easily keep track of the various state change requests from the audio control signals. For example, if the scheduled program of a broadcasting system is supposed to switch to a commercial break or another program during the transmission of an emergency message, the current EAS systems have no easy way of monitoring the necessary state changes required to make the switch. This problem becomes even more exacerbated if multiple state change requests are generated during an emergency message transmission. Additionally, problematically, any of the various state change requests generated by the audio control signals of a broadcasting system have the potential to interrupt or override the transmission of the emergency message before it is finished.

Accordingly, there is a need for systems and methods of transmitting an emergency message signal through a mainly digital transmission chain. Additionally, there is a need for systems and methods that can monitor state change requests for signal routers during the transmission of an emergency message. Moreover, there is a need for systems and methods that can prevent a state change request from interrupting an emergency message during its entire transmission.

### BRIEF DESCRIPTION OF THE INVENTION

The present disclosure offers advantages and alternatives over the prior art by providing methods and EAS systems for transmitting an emergency message signal through an AoIP transmission chain. The methods and systems can send a priority control signal to change the routing state of a routing system to a priority routing state, which is configured to transmit the emergency message signal. Advantageously, during the transmission of the emergency message signal, the systems and methods may store new routing states associated with incoming routing state change requests in a memory, wherein after the emergency message, the routing system may be restored to the most recently stored new routing state. Also advantageously, the systems and methods may continuously regenerate the priority control signal to keep the routing system in the priority routing state and to prevent any state change request from interrupting the emergency message transmission.

A method for transmitting an emergency message signal through an Audio-over-Internet Protocol (AoIP) transmission chain, in accordance with one or more aspects of the present disclosure, includes detecting an emergency message signal. A initial routing state of a routing system is read. The initial routing state is configured to select one or more audio input signals from an audio broadcasting system through a transmission chain. The initial routing state is stored as a new routing state in a memory. A priority control signal is generated to change this initial routing state of the routing system to a priority routing state. The priority routing state is configured to transmit the emergency message signal through the transmission chain. During the transmission of the emergency message signal, additional routing states, associated with incoming routing state change requests from an audio input control signal of the audio broadcasting system, are stored in the memory as the new routing state. Each additional routing state replaces the previously stored new routing state in the memory. After transmission of the emergency message signal, the routing system is restored to the most recently stored new routing state.

An EAS system for providing an emergency message signal through an Audio-over-Internet Protocol transmission chain, in accordance with one or more aspects of the present disclosure, includes at least one memory. One or more processors are in communication with at least one memory. The EAS system is configured to perform a method which includes detecting an emergency message signal. An initial routing state of a routing system is read. The initial routing state is configured to transmit one or more audio input signals from an audio broadcasting system through a transmission chain. The initial routing state is stored as a new routing state in a memory. A priority control signal is generated to change the initial routing state of the routing system to a priority routing state. The priority routing state is configured to transmit the emergency message signal through the transmission chain. The emergency message signal is transmitted through the transmission chain. During the transmission of the emergency message signal, additional routing states, associated with incoming routing state change requests from an audio input control signal of the audio broadcasting system, are stored in the memory as the new routing state. Each additional routing state replaces the previously stored new routing state in the memory. After the emergency message signal is transmitted, the routing system is restored to the most recently stored new routing state.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1 depicts an example of a flow diagram of a method, performed by an EAS system, of transmitting an emergency message signal through an Audio-over-Internet Protocol (AoIP) transmission chain, wherein a routing system is in an initial routing state, which is configured to transmit regularly scheduled audio input signals from an audio broadcasting system, according to aspects described herein;

FIG. 2 depicts an example of the flow diagram of FIG. 1, wherein the EAS system has forced the routing system to change to a priority routing state, which is configured to transmit an emergency message signal, according to aspects described herein; and

FIG. 3 depicts an example of the flow diagram of FIG. 1, wherein the EAS system has restored the routing system to a most recently stored new routing state, which is configured to resume transmission of the regularly scheduled audio input signals after the emergency message signal has been transmitted, according to aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to +5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

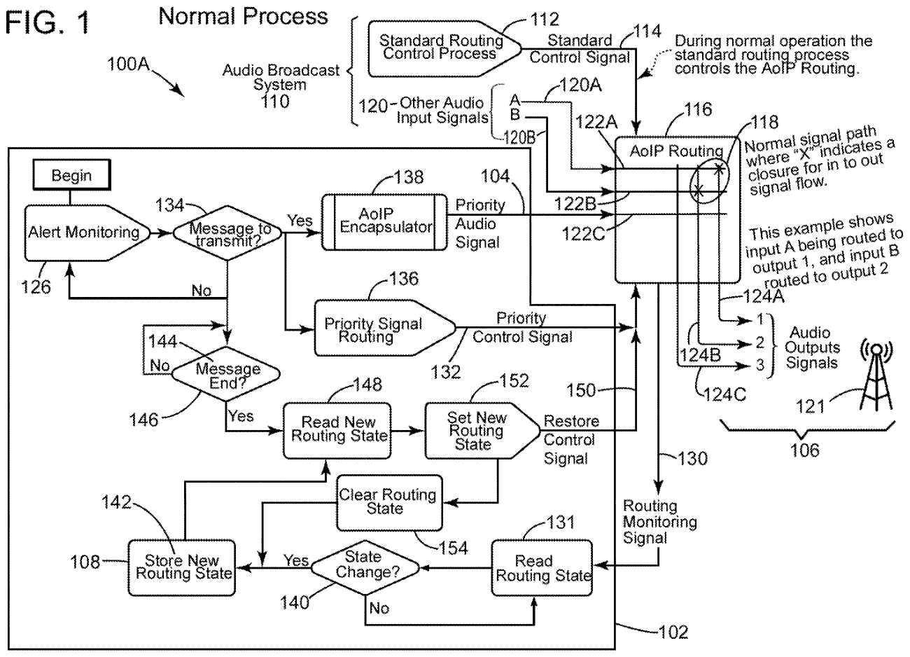

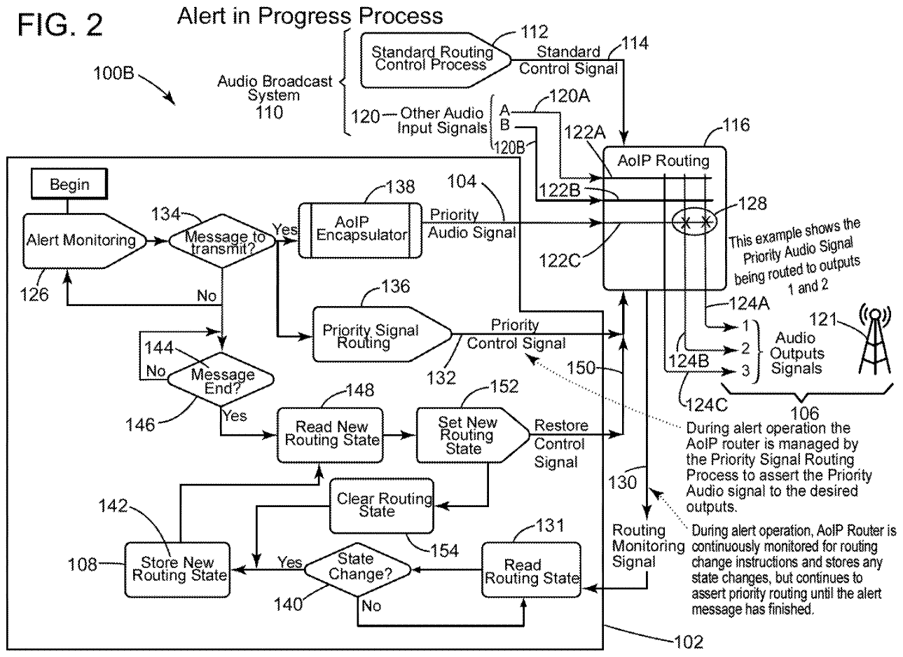

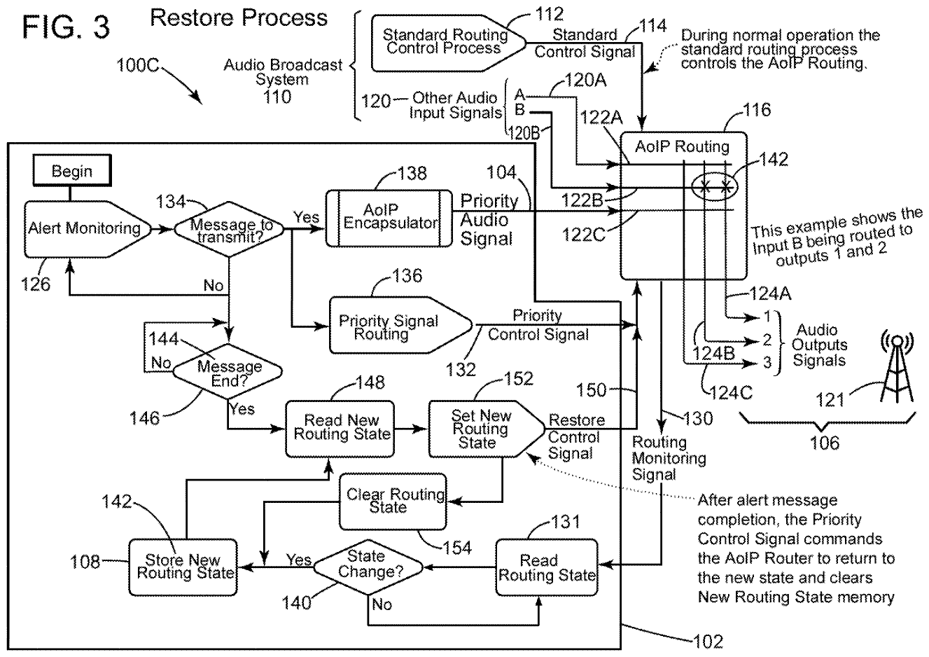

Referring to FIG. 1, an example is depicted of a flow diagram 100A of a method, performed by an EAS system 102, of transmitting an emergency message signal 104 (see FIG. 2) through an Audio-over-Internet Protocol (AoIP) transmission chain 106. The EAS system 102 includes at least one memory 108 and one or more processors (not shown), which communicate with the memory 108. The EAS system 102 is configured to perform the method depicted in flow diagrams 100A, 100B (FIGS. 2) and 100C (FIG. 3).

In the flow diagram 100A, an audio broadcasting system 110 and the EAS system 102 are operating in a normal broadcasting mode (or normal mode) of the method. More specifically in the normal broadcasting mode, a routing control process 112 of the broadcasting system 110 generates an audio input control signal (or standard control signal) 114 to control the routing states of a routing system 116. In the example illustrated in FIG. 1, the audio input control signal 114 has put the routing system 116 into an initial routing state 118, which is configured to transmit regularly scheduled audio input signals 120 from the audio broadcasting system 110 through the transmission chain 106.

As used herein, the audio input signals collectively are referred to with reference number 120. In the examples illustrated herein, there are two individual audio input signals 120A and 120B. However, the audio broadcasting system 110 may have any number of audio input signals 120 and may change the number of input signals at any time during its regularly scheduled programming.

During the normal mode 100A, the connections for the emergency alert signal 104, the priority control signal 132, the restore control signal 150 and the monitoring signal 130 of the EAS system 102 are in place. However, those signals 104, 130, 132, 150 are deactivated. On the other hand, the audio input control signal 114 of the audio broadcasting system 110 remains active during each mode (100A, 100B, 100C) of the method described herein.

A “system”, such as the aforementioned EAS system 102, audio broadcasting system 110 and routing system 116, as used herein, may include several physical and/or software elements to achieve a specific required functionality. The elements of a system may be positioned in locations remote from each other or in one single enclosure, depending on the design of the system.

In audio broadcasting, a transmission chain, or “airchain” as it's sometimes called, is the sequence of equipment and processes that an audio signal follows from its origin (like a microphone) to the final transmission point (i.e., the antenna or transmitter 121). As will be explained in more detail herein, it is important to note that the routing system 116 in this flow diagram 110A is the last switching system in the transmission chain 106 prior to the audio input signals 120 (or an emergency message signal 104) reaching the output which is exemplified as a transmitter 121 but may not necessarily be an over-the-air transmission.

As the regularly scheduled programming of the broadcasting system 110 changes (e.g., going to a commercial break or changing to a different program), so will the routing requirements for the audio input signals 120. Accordingly, the audio input control signal 114 will transmit routing state change requests to change the routing state of the routing system 116 to match the associated routing requirements of the input signals 120. These routing state change requests carry no particular priority and typically change the routing state sequentially with each routing state change request.

The routing system 116 depicted herein is configured as a matrix switching system, having three router inputs 122A, 122B and 122C (for the input signals 120A, 120B and a dedicated input for the emergency message signal 104) and three router outputs (124A, 124B, 124C). However, the routing system 116 can have any number of inputs and outputs. The initial routing state 118 depicts two virtual switch closures within the matrix, which are marked with an “X.” The specific switch closures indicated provide the following:
a transmission path for audio input signal 120A from router input 122A to router output 124A; and
a transmission path from audio input signal 120B from router input 122B to router output 124B.

During the normal broadcasting mode, the EAS system 102 is constantly monitoring for emergency message signals via a message monitoring system 126. However, in the normal broadcasting mode, the EAS system 102 is not communicating with the routing system 116 and is not generating an emergency message signal 104.

Referring to FIG. 2, an example is depicted of the flow diagram of FIG. 1, operating in a message mode 100B of the method. In the message mode 100B, the EAS system 102 has forced the routing system 116 to change to a priority routing state 128, which is configured to transmit an emergency message signal 104, according to aspects described herein.

During the message mode 100B, the emergency alert signal 104, the priority control signal 132, and the monitoring signal 130 of the EAS system 102 are activated. The restore control signal 150 remains deactivated. As mentioned earlier, the audio input control signal 114 of the audio broadcasting system 110 remains active in the message mode 100B.

In the message mode 100B of the method, the message monitoring system 126 of the EAS system 102 detects a message that rises to the level of an emergency message signal (or any priority audio signal) 104. The emergency message signal 104 may be for any event or potential event that can pose a threat to the general listening audience. For example, a tornado watch, a tornado warning, or an amber alert. Therefore, the emergency message signal 104 carries a higher priority than the normal audio input signals 120 that carry the regularly scheduled programs of the broadcasting system 110 and must be routed through the transmission chain 106 in place of the audio input signals 120.

However, just routing the emergency message signal 104 in place of the audio input signals 120A, 120B (as has been typically done in mainly analog broadcasting systems where the prior EAS systems were hard-wired switching systems), will not be sufficient. This is because changes to the routing states (i.e., virtual switching changes) in the routing system 116 are implemented via routing change requests embedded in the externally generated audio input control signal 114. If such routing change requests are lost during transmission of the emergency message signal 104, then the routing system will not be able to be restored to a proper routing configuration after the emergency message signal 104 has been transmitted.

More specifically, during the transmission of the emergency message signal 104, regularly scheduled program changes often occur (e.g. programs end, programs change, or programs switch to commercials), while the emergency message signal is being transmitted. For each program change, the routing control process 112 of the broadcasting system 110 generates and embeds a new routing change request within the audio input control signal 114 that is transmitted to the routing system 116. If the routing change control requests (especially the last routing state control request) that are generated during the transmission of the emergency message signal 104 are lost, then there will be no way of knowing which routing state to restore the routing system 116 to after the transmission of the emergency message signal 104 has ended.

As will be explained in greater detail herein, the routing control process 112 of the audio broadcasting system 110 and the priority signal routing system 136 of the EAS system 102 are asynchronous and do not communicate with each other. Accordingly, during transmission of an emergency alert message 104, both the EAS system 102 and the audio broadcasting system 110 may be trying to control the routing system 116 simultaneously. Therefore, it is important that the priority control signal 132 of the EAS system 102 have a higher priority compared to the audio input control signal 114 of the audio broadcasting system 110, to enable the EAS system to maintain control over the routing system 116 during transmission of an emergency message signal 104.

Advantageously, as will be explained in greater detail herein, the EAS system is configured to perform the method (depicted in flow diagrams 100A, 100B and 100C) whereby, during the transmission of the emergency message signal 104, additional routing states, associated with incoming routing state change requests from the audio input control signal 114 of the audio broadcasting system 110, are stored in the memory 108 of the EAS system 102 as a new routing state 142. Each additional routing state replaces the previously stored new routing state 142 in the memory 108. Therefore, after transmission of the emergency message signal 104, the routing system 116 may advantageously be restored to the most recently stored new routing state 142 (see FIG. 3), which seamlessly returns the outputs to the desired program even if changes to the program have occurred during the transmission of the emergency message signal 104. This represents a significant technical improvement over prior art EAS systems.

Referring again to FIG. 2, in the message mode 100B of the method, once an emergency message signal 104 has been detected by the message monitoring system 126 of the EAS system 102, an initial routing state 118 (see FIG. 1) of a routing system 116 is read. The initial routing state 118 is the routing state that is configured to transmit one or more of the audio input signals 120A, 120B from the audio broadcasting system 110 through the transmission chain 106 to the transmitter 121, just before the emergency audio signal 104 overrides the audio input signals 120A, 120B. In the flow diagram 100B of the method performed by the EAS system 102, the initial routing state 118 is read via a monitoring signal 130 being transmitted from the routing system 116 to the “reading” logic block (or “reading” logic system) 131 of the EAS system 102.

Next in the method, the initial routing state 118 is then stored as a new routing state 142 in the memory 108 of the EAS system.

Next in the method, a priority control signal 132 is generated to change the initial routing state 118 of the routing system 116 to the priority routing state 128. The priority routing state 128 is configured to transmit the emergency message signal 104 through the transmission chain 106. Because the priority control signal 104 carries a higher priority than the input audio signals 120A, 120B, the routing system 116 will switch from the initial routing state 118 to the priority routing state 128, effectively replacing the input audio signals 120A, 120B with the emergency message signal 104.

In the exemplary matrix network of routing system 116, the priority routing state 128 depicts two virtual switch closures within the matrix, which are marked with an “X.” The specific switch closures indicated provide a transmission path for the emergency message signal 104 from router input 122C (i.e., the router input dedicated to the emergency message signal 104) to both router outputs 124A and 124B. Accordingly, the priority routing state 128 configures the routing system 116 to transmit the emergency message signal 104 along the same transmission paths within the transmission chain 106 that the audio input signals 120A, 120B would.

Thereafter in the method, the emergency message signal 104 is transmitted through the transmission chain 106 to the transmitter 121. Because the routing system 116 is the last switching system in the transmission chain 106, the transmission of the emergency message signal 104 to the transmitter 121 cannot be interrupted.

More specifically, in the flow diagram 100B of the method performed by the EAS system 102, When an emergency message signal 104 is detected by the message monitoring system 126, “message” logic block (or “message” logic system) 134 signals a priority signal routing system 136 to generate the priority control signal 132. Additionally, the message logic block 134 also signals the AoIP Encapsulator system 138 to convert the emergency message signal 104 to an AoIP format. Thereafter the AoIP Encapsulator system 138 begins transmitting the emergency message signal 104 to the routing system 116. The AoIP format may meet, for example, the AES67 standard for interoperability, which was developed by the Audio Engineering Society based in New York City, New York.

Advantageously, the priority signal routing system 136 is configured to continuously regenerate the priority control signal 132 to keep the routing system 116 in the priority routing state 128 during the entire transmission of the emergency message signal 104. This is important because the routing control process 112 of the audio broadcasting system 110 also continues to transmit its audio input control signal 114 during the transmission of the emergency message signal 104. Therefore, if the priority control signal 132 where not continuously generated to continuously assert priority, then any state change requests within the audio input control signal 114 that occur during the transmission of the emergency message signal 104 could interrupt the continuity of that transmission.

Next in the method, the routing system is continuously monitored for any incoming routing state change requests. This may be done via the monitoring signal 130 continuously transmitting the audio input control signal 114 to the reading logic block 131 of the EAS system 102. Routing state change requests embedded in the audio input control signal 114 can then be checked in the “state change” logic block (or “state change” logic system) 140 of the EAS system 102.

Next in the method, during the transmission of the emergency message signal 104, additional routing states associated with incoming routing state change requests embedded in the audio input control signal 114 may be stored in the memory 108 of the EAS system as the new routing state 142. Each additional routing state replaces the previously stored new routing state 142 in the memory 108 of EAS system 102.

Advantageously, after transmission of the emergency message signal 104 has ended, the routing system 116 may be restored to the most recently stored new routing state 142 (see FIG. 3). Restoring the routing system 116 to the most recently stored new routing state 142, which is associated with the most recently generated change of state request, enables the listening audience to be seamlessly returned to the regularly scheduled program even if changes to the program have occurred during the transmission of the emergency message signal 104.

Referring to FIG. 3, an example is depicted of the flow diagram of FIG. 1 operating in the restore mode 100C of the method. In the restore mode, the EAS system 102 has restored the routing system 116 to a most recently stored new routing state 142, which is configured to resume transmission of the regularly scheduled audio input signals 120A, 120B after the emergency message signal 104 has been transmitted, according to aspects described herein.

During the restore mode 100C, the restore control signal 150 of the EAS system 102 is activated. The emergency alert signal 104, the priority control signal 132, and the monitoring signal 130 of the EAS system 102 are deactivated. As mentioned earlier, the audio input control signal 114 of the audio broadcasting system 110 remains active in the restore mode 100C.

In the method, the step of restoring the routing system 116 to the most recently stored new routing state 142, may be described in further detail as follows.

Next in the method, an “end of message signal” 144 at the end of the emergency message signal 104 is detected and the emergency message signal 104 is no longer transmitted. The end of message signal 144 may be detected in the “message end” logic block (or “message end” logic system) 146 of the EAS system 102.

At the end of the emergency message signal 104, the priority control signal 132 may be turned off. This may be accomplished in several ways. For example, the priority control signal 132 may be turned off by the end of message signal 144 communicating to the priority signal routing system 136 that it must stop generating a priority control signal 132.

Additionally at the end of the emergency message signal 104, the monitoring signal 130 may also be turned off. This may be accomplished in several ways. For example, the monitoring signal 130 may be turned off by the end of message signal 144 communicating to the reading logic block 131 to stop generating or stop reading monitoring signal 130.

Next in the method, the most recently stored new routing state 142 in the memory 108 is read. This may be accomplished by the “read new routing state” logic block (or “read new routing state” logic system) 148 getting a communication from the message end logic block 146 to read the most recently stored new routing state 142 in the memory 108 of the EAS system 102.

Next in the method, a restore control signal 150 is transmitted to the routing system 116 in place of the priority control signal 132 to change the priority routing state 128 to the most recently stored new routing state 142. This may be accomplished by the read new routing state logic block 148 triggering a “set new routing state” logic block (or “set new routing state” logic system) 152 to generate the restore control signal 150, which restores the routing state of the routing system 116 to the most recently stored new routing state 142.

Next in the method, the most recently stored new routing state 142 is cleared from the memory 108 of the EAS system 102, after the routing system 116 has been restored to the most recently stored new routing state 142. This may be accomplished by the set new routing state logic block 152 communicating to a “clear routing state” logic block (or “clear routing state” logic system) 154 to clear the most recently stored new routing state 142 from the memory 108 of the EAS system 102.

Next in the method, the one or more audio input signals 120A 120B are made to resume transmission through the transmission chain 106 after the routing system 116 has been restored to the most recently stored new routing state 142.

In the exemplary matrix network of routing system 116, the most recently stored new routing state 142 depicts two virtual switch closures within the matrix, which are marked with an “X.” The specific switch closures indicated provide a transmission path for the audio input signal 120B from router input 122B to both router outputs 124A and 124B. Note that the audio input signal 120A no longer has a transmission path through the router system 116. This is because the programming carried on audio input signal 120B is being broadcast to the audiences listening to the signal transmitted from router output 124A and the signal transmitted from router output 124B. The program being transmitted from audio input signal 120A has ended and is no longer being transmitted to an audience.

The above changes in programming and their associated changes in the routing state of the routing system happened during the transmission of the emergency message signal 104.

However, the method 100A, 100B, 100C described herein is advantageously capable of monitoring (via monitoring signal 130), storing (in memory 108) and restoring (via restore control signal 150) the routing system 116 to the most recently stored new routing state 142. Accordingly, the output(s) can be seamlessly returned to the regularly scheduled programming even if changes to the routing state have occurred during the transmission of the emergency message signal 104.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it has the full scope defined by the language of the following claims.

What is claimed is:

1. A method for transmitting an emergency message signal through an Audio-over-Internet Protocol (AoIP) transmission chain, the method comprising:
detecting an emergency message signal;
reading an initial routing state of a routing system, the initial routing state configured to transmit one or more audio input signals from an audio broadcasting system through a transmission chain;
storing the initial routing state as a new routing state in a memory;
generating a priority control signal to change the initial routing state of the routing system to a priority routing state, the priority routing state configured to transmit the emergency message signal through the transmission chain;
transmitting the emergency message signal through the transmission chain;
during the transmission of the emergency message signal, storing in the memory, as the new routing state, additional routing states associated with incoming routing state change requests from an audio input control signal of the audio broadcasting system, each additional routing state replacing the previously stored new routing state in the memory; and
after transmission of the emergency message signal, restoring the routing system to the most recently stored new routing state.

2. The method of claim 1, comprising:
continuously regenerating the priority control signal to keep the routing system in the priority routing state during the entire transmission of the emergency message signal.

3. The method of claim 1, comprising:
continuously monitoring the routing system for any incoming routing state change requests, prior to storing the additional routing changes associated with the routing state change requests as the new routing state.

4. The method of claim 1, comprising:
converting the emergency message signal to an AoIP format prior to transmitting the emergency message signal to the routing system.

5. The method of claim 4, wherein the AoIP format meets the AES67 standard developed by the Audio Engineering Society of New York City, NY.

6. The method of claim 1, wherein restoring the routing system to the most recently stored new routing state, comprises:
detecting an end of message signal at an end of the emergency message signal;
reading the most recently stored new routing state in the memory; and
transmitting a restore control signal to the routing system in place of the priority control signal to change the priority routing state to the most recently stored new routing state.

7. The method of claim 6, comprising:
clearing the most recently stored new routing state from the memory after the routing system has been restored to the most recently stored new routing state.

8. The method of claim 7, comprising:
resuming a signal flow of the one or more audio input signals through the transmission chain after the routing system has been restored to the most recently stored new routing state.

9. The method of claim 1, wherein the routing system is the last routing system in the transmission chain.

10. The method of claim 1, wherein the transmission chain is configured to transmit from the audio broadcasting system to a transmitter.

11. An EAS system for providing an emergency message signal through an Audio-over-Internet Protocol transmission chain, the EAS system comprising:
at least one memory; and
one or more processors in communication with the at least one memory, wherein the EAS system is configured to perform a method, the method comprising:
detecting an emergency message signal,
reading an initial routing state of a routing system, the initial routing state configured to transmit one or more audio input signals from an audio broadcasting system through a transmission chain,
storing the initial routing state as a new routing state in the at least one memory,
generating a priority control signal to change the initial routing state of the routing system to a priority routing state, the priority routing state configured to transmit the emergency message signal through the transmission chain,
transmitting the emergency message signal through the transmission chain,
during the transmission of the emergency message signal, storing in the at least one memory, as the new routing state, additional routing states associated with incoming routing state change requests from an audio input control signal of the audio broadcasting system, each additional routing state replacing the previously stored new routing state in the at least one memory, and
after transmission of the emergency message signal, restoring the routing system to the most recently stored new routing state.

12. The EAS system of claim 11, wherein the method comprises:
continuously regenerating the priority control signal to keep the routing system in the priority routing state during the entire transmission of the emergency message signal.

13. The EAS system of claim 11, wherein the method comprises:
continuously monitoring the routing system for any incoming routing state change requests, prior to storing the additional routing changes associated with the routing state change requests as the new routing state.

14. The EAS system of claim 11, wherein the method comprises:
converting the emergency message signal to an AoIP format prior to transmitting the emergency message signal to the routing system.

15. The EAS system of claim 14, wherein the method comprises the AoIP format meeting the AES67 standard developed by the Audio Engineering Society of New York City, NY.

16. The EAS system of claim 11, wherein, in the method, the restoring the routing system to the most recently stored new routing state, comprises:
detecting an end of message signal at an end of the emergency message signal;
reading the most recently stored new routing state in the memory; and
transmitting a restore control signal to the routing system in place of the priority control signal to change the priority routing state to the most recently stored new routing state.

17. The EAS system of claim 16, wherein the method comprises:
clearing the most recently stored new routing state from the memory after the routing system has been restored to the most recently stored new routing state.

18. The EAS system of claim 17, wherein the method comprises:
resuming a signal flow of the one or more audio input signals through the transmission chain after the routing system has been restored to the most recently stored new routing state.

19. The EAS system of claim 11, wherein the routing system is the last routing system in the transmission chain.

20. The EAS system of claim 11, wherein the transmission chain is configured to transmit from the audio broadcasting system to a transmitter.
